(19) United States
(12) Patent Application Publication
(10) Pub. No.: US 2003/0183976 A1
(43) Pub. Date: Oct. 2, 2003

(54) Double bubble process for manufacturing orientated cellulose films

(76) Inventors: Ivo G. Hendriks, Overpelt (BE); Roger H. Hendrikx, Zonhoven (BE); Stefan D. Beckers, Hechtel-Eksel (BE); Mark Vrijsen, Zonhoven (BE); Dirk M. Hellemans, Baal (BE)

Correspondence Address: JENKENS & GILCHRIST, PC, 1445 ROSS AVENUE, SUITE 3200, DALLAS, TX, 75202, US

(21) Appl. No.: 10/221,597

(22) PCT Filed: Mar. 1, 2001
(86) PCT No.: PCT/GB01/00851

(30) Foreign Application Priority Data
Mar. 18, 2000 (GB) 0006524.3

(51) Int. Cl. B29C 47/20; B29C 55/28

(52) U.S. Cl. 264/187; 264/203; 264/569; 425/71

(57) ABSTRACT

This application relates to producing biaxially stretched tubular cellulose films for the food industry. In particular, the biaxial stretching is obtained by using rollers to stretch the casings longitudinally and to use increased air pressure inside the films to radially stretch the casings. The obtained product may also be cut to provide longitudinal strips for the production of smaller tubular films.

This invention relates to tubular food casings such as those commonly used for encasing foods such as sausages. More particularly, this invention relates to using biaxially stretched material in the manufacture of tubular food casings.

Cellulose tubular films are used in the food industry for casings, primarily for meat products such as sausages. Typically, cellulose tubular films such as cellulose casings have been made for many years according to the viscose process. This process is more than a century old and has been used commercially for about 95 years. In this process, cellulose is typically taken from one source, derivatised, then solubilised and then articles are formed by extruding a solubilised derivatised cellulose into fibres, sheets or tubes. Reforming the cellulose is carried out via a process called regeneration.

The basic raw material for cellulose casings is cellulose pulp which usually comes from wood pulp. Other major raw materials used in the viscose process are carbon disulphide, sodium hydroxide, sulphuric acid and a plasticising agent. The viscose preparation process is a complicated process and usually requires multiple separate steps before the solubilised cellulose is ready to be used in the manufacture of a cellulose product. Although the viscose process has generally worked well, separation time from steeping to extrusion is a considerable disadvantage, as is the use of various raw materials which give rise to disposal problems and other potential pollution and associated environmental problems.

The new process which has become popular and is replacing the viscose process involves the creation of a special type of extrusion solution called “dope” instead of viscose. Dope is a solution of cellulose dissolved in tertiary amine oxide and water. The preferred tertiary amine oxide is NMMO (N-methyl morpholine N-oxide). One advantage of using this solvent is that it is able to dissolve cellulose without having to derivatise it first, as was required in the viscose process using materials such as carbon disulphide. A second advantage of the amine-oxide process is that once solubilised, the cellulose can be precipitated from the dope as a regenerated product by contacting the dope with a precipitation liquid, typically water which is a non-solvent for cellulose but a solvent for NMMO. A further advantage is that the process time before extrusion is significantly reduced. A yet further advantage is that much less raw materials are required and the NMMO solvent together with excess water, used in the processes during the precipitation and washing stage, can be recycled and reused.

U.S. Pat. No. 4,556,708 describes a non-reinforced sausage casing which has certain minimal tear strength in both longitudinal and transverse directions. However, such strengths are not as high as desired relative to their cross-sectional areas. Shrink and stretch properties are also poor.

U.S. Pat. No. 4,940,614 similarly describes a tubular material seamed parallel to a longitudinal axis by means of an adhesive tape. Again the strength of the cellulose based material is not as high as desired relative to the cross-sectional area. Shrink and stretch properties are also not as good as desired.

It is therefore an object of the present invention to provide a method and apparatus for producing extruded blown tubular film wherein further strength is imparted to the tubular film.

It is a further object of the present invention to provide a method and apparatus for biaxially stretching an extruded blown tubular film.

According to a first aspect of the present invention there is provided a method for producing biaxially stretched extruded cellulose based tubular film wherein the tubular film is extruded from an extrusion die and sequentially transporting the tubular film through a liquid precipitation bath and a dryer, said method comprising the steps of:

locating the extrusion die above the liquid precipitation bath having a precipitation liquid level therein to provide a gap between an extrusion nozzle outlet of the extrusion die and the surface of the precipitation liquid in the liquid bath;

extruding a blown tubular film from the extrusion die so that a bubble is formed in the gap between the extrusion nozzle outlet and the liquid precipitation bath and wherein there is increased air pressure within the bubble;

pulling the tubular film away from the extrusion die and into the precipitation bath using a set of rollers;

precipitating the blown tubular film in said liquid precipitation bath; and

wherein the film is transported via further sets of rollers to form at least one further bubble, between a set of rollers, where the tubular film is further stretched to impart additional strength to the film.

Preferably, the tubular film is cellulose based and is formed by adding cellulose to a water diluted NMMO solution to form a suspension, wherein the suspension is heated and the water evaporated under reduced pressure to form NMMO monohydrate which dissolves the cellulose to form a dope solution containing cellulose, NMMO-monohydrate and water.

It is preferred if nip rolls are used to stretch the tubular film.

Preferably, the nip rolls terminating the first bubble rotate faster than the rate of extrusion from the extrusion die so that there is a longitudinal tension in the tubular cellulose film.

Preferably, the air pressure in the first bubble use 0.1 to 5 mbar.

Preferably, a second bubble in the tubular film is formed after it has been washed in wash tanks and plasticiser tanks.

Preferably, the film is formed into three bubbles prior to being wound on a drum. Preferably, the cellulose film in a wet condition is stretched by nip rolls longitudinally and radially by increased air pressure; and in the third bubble the pressure inside the film is increased.

Alternatively, the film in a wet condition is stretched by nip rolls longitudinally and radially by increased air pressure; and the third bubble the pressure inside the film is decreased.

A further alternative is for the cellulose film to be dried and stretched by nip rolls longitudinally by and radially by increased air pressure; and the third bubble is rewetted and further stretched between nip rolls and by using increased air pressure.

Furthermore, it is preferred if the second bubble has a set of nip rolls at both ends of the bubble and wherein the set of nip rolls first in contact with the tubular film rotate slower than the second set of nip rolls whereby a longitudinal tension is created in the film. Alternatively, a holding/accumulator tank is located between each set of rollers.

Preferably, the air pressure inside the second bubble is 50 to 800 mbar.

Preferably, the tube is stretched by a total of 20-1500% in the longitudinal direction and 20-2000% in the transverse direction.

According to a second aspect of the present invention there is provided apparatus for producing biaxially stretched extruded cellulose based tubular film of improved strength wherein the apparatus contains an extrusion die above a liquid bath having a liquid level therein to provide a gap between the die and the surface of the liquid in the liquid bath wherein the film is extruded into a first bubble and pulled via a set of rollers and wherein the film undergoes a process of being pulled through further rollers between which film bubbles are formed which exert further biaxial forces on the tubular film.

Preferably, the rollers are nip rolls.

According to a third aspect of the present invention, there is provided a biaxially stretched tubular cellulose based film as described herein.

Preferably, the tubular cellulose based film is cut into a plurality of biaxially stretched strips and the biaxially stretched strips are seamed to form a smaller dimensioned tubular film. The seams are conveniently formed by using tape such as adhesive tape, heat sealing tape or any other suitable adhesive means.

Advantageously, the cuts are parallel with a longitudinal axis of the formed tubular film. Alternatively, the seams are helical with respect to the formed tubular film.

Embodiments of the present invention will now be described, by way of example only, with reference to the accompanying drawings in which:

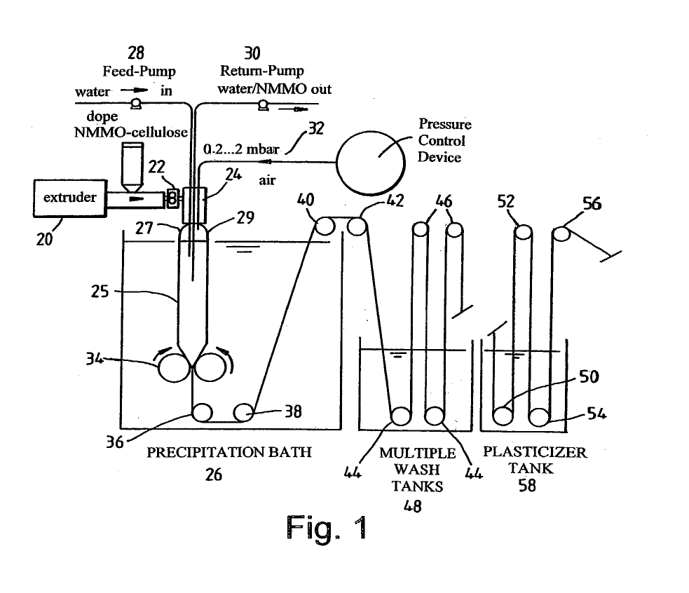

FIG. 1 is a schematic representation of a conventional NMMO-cellulose dope processing unit;

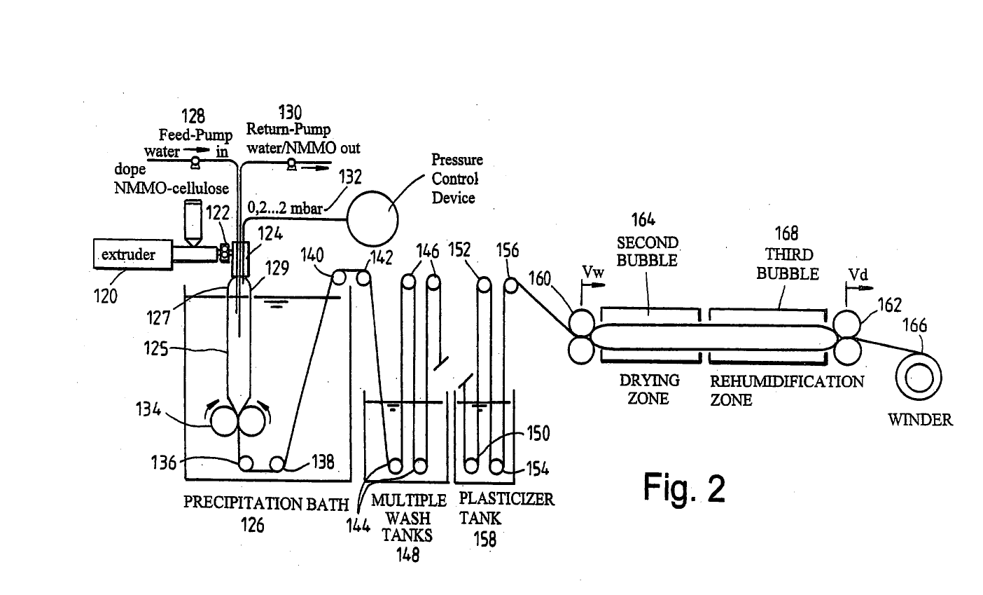

FIG. 2 is a schematic representation of an NMMO-cellulose dope processing unit comprising a double bubble and further nip rolls;

FIG. 3 is a schematic representation of an NMMO cellulose dope processing unit comprising a triple bubble;

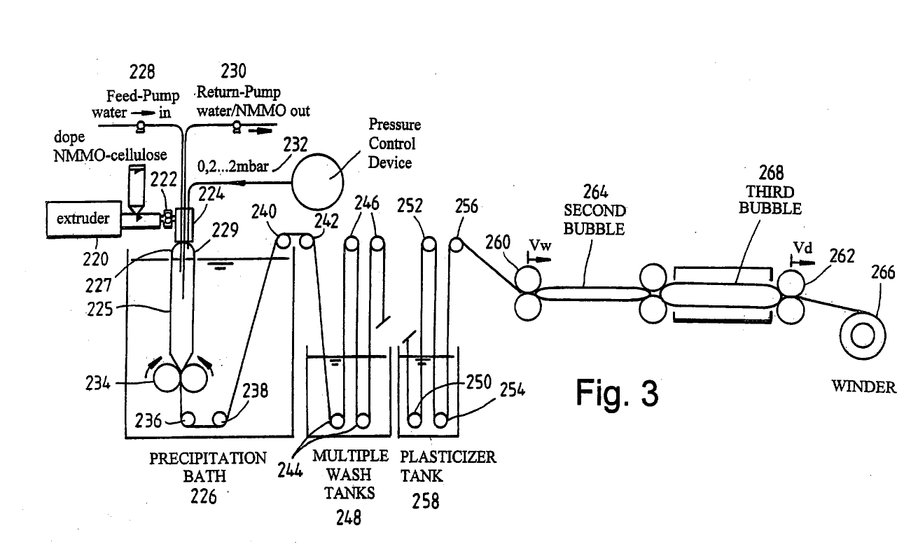

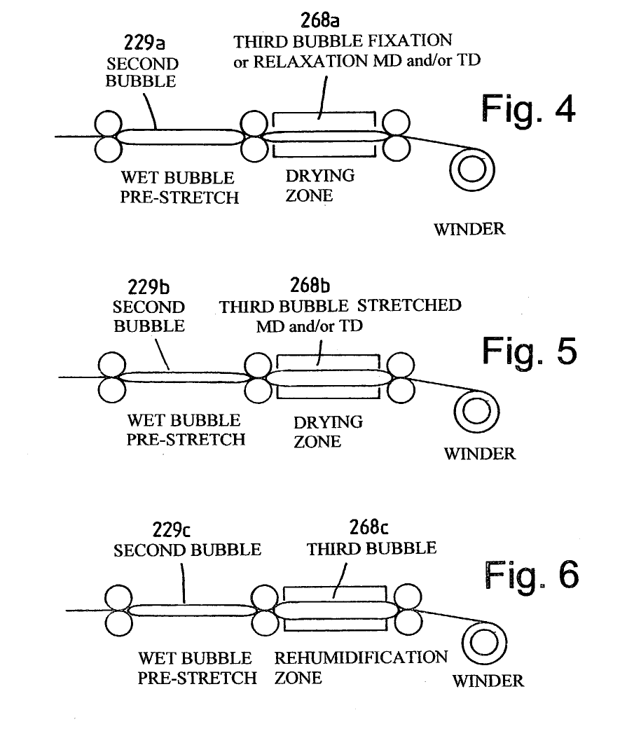

FIG. 4 is a schematic representation of the second and third bubble in FIG. 3 wherein the cellulose casing is pre-stretched in the second bubble and relaxed or fixated during drying in the third bubble;

FIG. 5 is a schematic representation of the second and third bubble in FIG. 3 wherein the cellulose casing is pre-stretched in the second bubble and stretched during drying in the third bubble;

FIG. 6 is a schematic representation of the second and third bubble in FIG. 3 wherein the cellulose casing is dried in the second bubble and then rewetted in the third bubble;

FIG. 7 shows a tubular film with longitudinal edges wherein the edges abut each other;

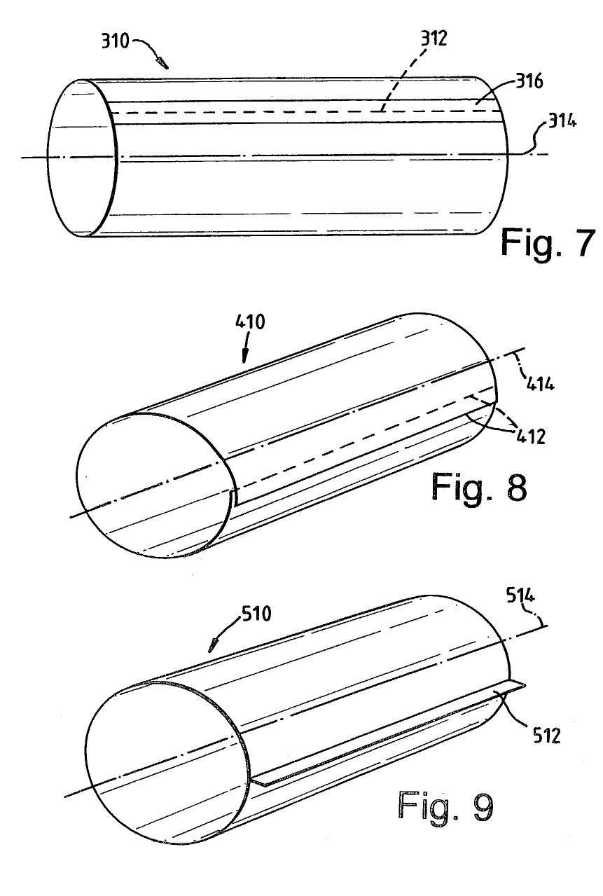

FIG. 8 shows a tubular film with longitudinal edges wherein the longitudinal edges overlap;

FIG. 9 shows a tubular film with longitudinal edges wherein the longitudinal edges are face-to-face;

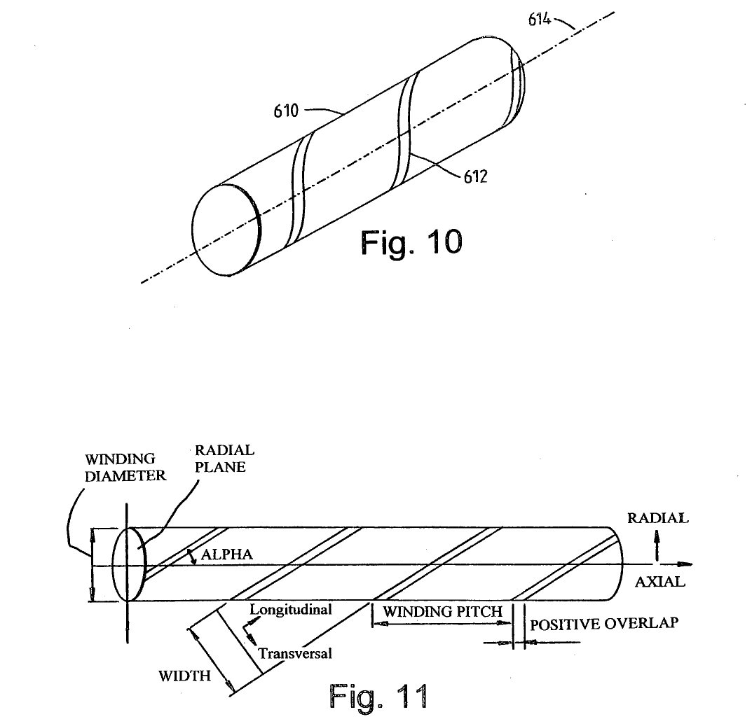

FIG. 10 shows a tubular film wherein the film is seamed in a helical form; and

FIG. 11 is a schematic representation of a further tubular film.

Referring to FIG. 1, there is shown a typical representation of an extrusion process. NMMO-cellulose dope is fed into an extruder 20 at an extrusion temperature of about 100° C. and transported through a filter screen (not shown) to a gear metering pump section, shown generally at 22.

The metering pump section 22 feeds an extrusion die 24 which has a die outlet in the shape of an annular nozzle. The die outlet is directed downwardly to face a precipitation bath, shown generally at 26. Bath 26 is separated from die 24 by an air gap.

Tubular cellulose casing 25 is precipitated in bath 26 which contains a precipitation liquid, usually water, at a temperature in a range of 10-20° C.

A volume of water is provided to the interior of the tubular cellulose casing 25 via a feed pump supply means and conduit, shown generally at 28, which precipitates the interior of the cellulose casing 25.

Excess water NMMO solution (containing possible minor additives) is withdrawn from the interior of the cellulose casing 25 via a conduit 30 and pump. Section 27 of the casing 25 which lies in the air gap between the bath 26 and the extrusion die 24 is pressurised internally with air at a pressure of between 0.2 to 2 mbar above atmospheric pressure. The increased air pressure is supplied via pressure control means, shown generally at 32.

After the tubular cellulose casing 25 has precipitated in the precipitation bath 26, the tubular cellulose casing 25 is flattened and pulled through nip rolls 34. A first bubble 29 is therefore created in the casing 25 between the extrusion die 24 and the nip rolls 34. The nip rolls 34 rotate faster than the rate of extrusion from the extrusion die 24. There is, therefore, a tension in the longitudinal direction of the tubular cellulose casing 25 due to the pulling force of the nip rolls 34. There is also a tension in the transverse direction due to the pressurised air in section 27 of the casing 25.

After passing the cellulose casing 25 through the nip rolls 34, the casing 25 is wound about a set of rollers 36, 38, 40. The cellulose casing 25 then exits the precipitation bath 26.

The cellulose casing 25 is then transported, via rollers 42, 44, 46, through multiple wash tanks 48 and, via rollers 50, 52, 54, 56, through plasticiser tank 58.

In FIG. 2, there is shown the improved cellulose tubular film production apparatus. The apparatus in FIG. 2 is exactly the same as that of FIG. 1 in the precipitation bath 126, multiple wash tanks 148 and plasticiser tank 158. However, after the plasticiser tank 158 the wet casing is sequentially transported through a dryer and a rehumidifier wherein there are further sets of nip rolls 160, 162 and a second bubble 164.

In the first bubble 129, to obtain radial strength the tubular cellulose casing 125 is inflated (i.e. pressurised in the region between the extrusion die 124 and the precipitation bath 126). To obtain longitudinal strength, the tubular cellulose casing 125 is pulled longitudinally by nip rolls 134. The tubular cellulose casing 125 is longitudinally stretched by means of nip rolls 134 which rotate faster than the rate of extrusion. The tubular cellulose casing 125 is radially stretched by using increased air pressure in bubble 129. Air may be used as the expansion gas. In the case of cellulose, stretch from regeneration or precipitation applied to the first bubble 129 is usually about 1:1.1 to 1:4 in the radial direction and 1:1.1 to 1:10 in the longitudinal direction.

After regeneration and/or solvent removal, the tubular cellulose casing 125 is washed in wash tanks 148 and plasticised in plasticiser tanks 158.

Additional improvements to the strength and membrane properties of the tubular cellulose casing 125 are then obtained by using a second bubble 164. As shown in FIG. 2, the second bubble 164 is captured between a pair of driven nip rolls 160, 162. In the second bubble 164, further radial and longitudinal stretching is applied prior to and during drying. Pressurised air, ranging from 50 to 800 mbar, is fed into bubble 164. This second bubble 164 will improve the strength and membrane properties. Tension distribution will also be balanced by the second bubble 164.

The radial stretch applied to the second bubble 164 is in the range of 1:1 to 1:4. The longitudinal stretch, as applied simultaneously, is in the range of 1:1 to 1:4.

The type of crystalin orientation obtained in the tubular cellulose casing 125 is dependent on the direction of the stretch i.e. the machine direction orientation (MDO) obtained by the extrusion velocity and the nip rolls 134, 160, 162 and the transverse direction orientation (TDO) obtained by the air pressurisation in the bubbles 129, 164.

The dry flat width (DFW) is defined as the lay-flat width of the dried reel stock. The wet flat width (WFW) is defined as the lay-flat width of the wet tube prior to drying. The ratio of dry flat width to wet flat width is called radial drier stretch (RDS). Depending on the radial dryer stretch (RDS), the orientation and strength properties of the dried cellulose tube may be varied.

The machine direction orientation (MDO) in the second bubble 164 is obtained by applying a different speed to the nip rolls 160, 162. Nip rolls 160 rotate slightly slower than nip rolls 162 so that a longitudinal tension is obtained in the tubular casing 125.

The longitudinal drier stretch (LDS) is defined as the ratio of inlet speed (Vw) to outlet speed (Vd). Suitable ratios range from 1:1 to 1:4.

After drying, the biaxially stretched tubular cellulose casing 125 is rolled onto a winder 166.

FIG. 3 shows an NMMO-cellulose dope processing unit wherein three bubbles 229, 264, 268 are used to stretch the cellulose casing 225. FIGS. 4, 5 and 6 represent different conditions for the second 264 and third bubble 268.

FIG. 4 shows the second bubble 229a, in a wet condition, being stretched in the machine direction orientation (MDO) and in the transverse direction orientation (TDO). The third bubble 268a is relaxed or fixated by reducing the pressure in a drying zone.

FIG. 5 shows the second bubble 229b, in a wet condition, being stretched in the machine direction orientation (MDO) and in the transverse direction orientation (TDO). The third bubble 268b is further stretched in the machine direction orientation (MDO) and transverse direction orientation (TDO) during drying, by increasing the pressure in the bubble 268b.

FIG. 6 shows the second bubble 229c being dried first of all and then stretched. The third bubble 268c is rewetted and stretched by increasing the air pressure.

The use of a second and/or third stretching bubble allows the final properties of the tubular cellulose casing to be modified. Stretching in a longitudinal dryer is advantageous as this improves biaxial orientation and allows thinner films to be produced.

Optionally, after drying, the biaxially stretched tubular casings 125;225 are slit into multiple longitudinal strips for the manufacture of multiple seamed food casings. These seamed food casings have a much smaller diameter than the seamless tubular film 125;225. The slits are parallel to the machine direction orientation (MDO).

As shown in FIGS. 7, 8 and 9 each strip of film has parallel longitudinal edges 312; 412; 512. The parallel longitudinal edges 312; 412; 512 are curved towards each other about a longitudinal axis 314; 414; 514 so that the edges are proximate to each other to form a tube 310; 410; 510. The edges 312; 412; 512 may abut (FIG. 7), overlap (FIG. 8) or be face-to-face (FIG. 9). The longitudinal edge 312; is sealed together either directly or by means of a sealing tape 316. When the edges 312 are sealed together in face-to-face (FIG. 9) orientation, the resultant seam protrudes, generally radially, from the formed tube 510. The advantage of slitting the larger diameter tubular casing 125 is that much smaller tubular casings 310; 410; 510 with uniform construction may be obtained.

As shown in FIG. 10, another possibility is to wind the longitudinal strips, obtained by slitting, in a helical form. A tubular seamed casing 610 may then be built up with one or more layers. Some of the layers may be wound in opposite directions. Alternatively, all of the layers are wound in the same direction. The winding pitch may also be altered to provide a positive, negative or no overlap. The winding angle may range from 0 degrees to 90 degrees. The layer to form the casing 610 may be made of flat, opened and slit tubular film. Alternatively, the casing 610 is formed from a flattened tubular film. The width of the flat film may vary from the thickness of the flat film to several millimetres.

As shown in FIG. 11, a spiral wound tube 710 has a circular cross-section and is commonly called the winding diameter. The winding diameter can vary from 10 mm to 300 mm. By varying the winding pitch, winding diameter and winding width it is possible to alter the properties of the obtained tube. For example, it is possible to stiffen the tube in one direction and at the same time increase the flexibility in the opposite direction. Another possibility is to use extremely thin casings in a multilayer principle. Layers with different properties may be wound on top of each other to produce casings with different skin behaviour.

The seal 612 is achieved via any suitable means or methods. For example, heat sealing or an adhesive such as an acrylate adhesive is used e.g. methyl methacrylate or cyanoacrylate. When the seal is a heat seal, and the base film is a cellulose film, the film is coated with a heat sealing polymeric material such as polyvinylidene chloride.

The finished seamed tubular food casing 310; 410; 510; 610, as shown in FIGS. 7, 8, 9 and 10, may be collected on a reel for later use in, for example, food stuffing operations. In food stuffing operations, lengths of food casings are radially folded and longitudinally compressed to form shirred strands for placement over a food stuffing horn in a subsequent stuffing operation. The unique characteristic of the food casing of the present invention is that it may be formed immediately prior to stuffing which permits a continuous food stuffing operation not obtainable with real stock or shirred strands.

It is to be understood that usual treatments may be applied to the casings of the invention either before formation of the seamed tube or subsequent to such formation. Examples of such treatments include peeling aids, anti-blocking agents; plasticisers; crimping; colourants such as food approval dyes or smoke; heat sealing coatings; flavourings such as smoke and vapour; moisture barrier coatings and laminations.

The seamed casings of the present invention when properly biaxially stretched have good dimensional stability both radially and longitudinally, even when stuffed with wet food products. The casings of the present invention will radially shrink with contained food product as the food product temperature rises. The casings will also retain a consistent longitudinal dimension even when a finished stuffed product is hung by one end of the casing.

### EXAMPLE 1

Solutions were prepared with a laboratory mixer with 9.5% cellulose was mixed with 2% (w.r.t. cellulose) propylgallate. The propylgallate acts as a stabiliser.

The chopped cellulose pulp was preprocessed with a water/NMMO mixture of 50%. The temperature was increased to 95° C. while simultaneously applying a vacuum of 50 to 80 mbar. This caused the NMMO concentration in the solvent to increase up to about 88%. The NMMO concentration was determined with a refractometer and the complete dissolution of the cellulose pulp was checked by polarisation microscopy.

A cellulose film was extruded according to FIG. 1. An extrusion die with a nozzle diameter of 22 mm was used. The extrusion temperature was 100° C. The extruded cellulose tubular casing was washed to remove the NMMO solvent. The washed samples were not plasticised before drying. The machine direction orientation (MDO) in extrusion was 1:4. Two films were produced with different extrusion transverse direction orientation (TDO). Sample A has a transverse direction orientation (TDO) of 1:1.6 and Sample B has a transverse direction orientation (TDO) of 1:1.8.

Both samples were dried using a radial dryer stretch (RDS) of 1:1.6 and longitudinal dryer stretch (LDS) of 1:1.15

Both samples were analysed, in the dried and rewet condition, for break stress and maximum elasticity modulus on a Zwick stress/strain tester.

The tensile measurements were performed on a universal testing machine Zwick Z 020 along the procedures of EN ISO 527-3 using the cross-head position to monitor the strain. Table 1 shows the influence of extrusion transverse orientation on the break stress of the formed dry films.

Table 1 shows that increasing the TDO will increase the break stress of the resulting cellulose film, especially in the transverse directions.

Besides the stress at the breaking point, the dry modulus is also very important for sausage packaging films. The modulus is a measure of the stiffness and was determined as the maximum derivative of the whole stress-strain curve.

Table 2 shows the maximum elasticity modulus for both samples after drying. Table 2 shows that increasing the transverse direction orientation (TDO) in the first bubble (i.e. between the extrusion die and the precipitation bath) increases the transverse elasticity modulus. As the tube is blown up, the tube increases in the radial direction, with the resultant film becoming stiffer in the transverse direction.

### EXAMPLE 2

A cellulose film was produced according to the double bubble principle of FIG. 2. The dope prepared was similar to Example 1. Example 2 shows the influence of using a second bubble on the formed film.

In this Example, the forces applied to the first bubble were kept constant and three different radial dryer stretch ratios were applied to the second bubble. The transverse direction orientation (TDO) in the first bubble was 1:1.6 and the machine direction orientation (MDO) was 1:3. The film was precipitated, washed and not plasticized before drying.

Three samples C, D and E were produced with respectively 1:1.35; 1:1.46 and 1:1.53 radial dryer stretch (RDS). The longitudinal dryer stretch was kept constant at 1:1.15. Table 3 shows the influence of varying radial dryer stretch on break stress of the dried samples.

From Table 3 it can be concluded that increased radial dryer stretch (RDS) increases the transverse direction (TD) break stress of the dried film.

Samples C, D and E were rewetted with water after drying and the break stress was measured in the rewet condition. The rewetting involved immersing the dried samples for fifteen minutes in a water bath at room temperature.

Table 4 shows the stress results for the rewet samples. From Table 4 it can be concluded that increased radial dryer stretch (RDS) increases the transverse direction (TD) break stress of the rewetted film.

Table 5 shows the maximum modulus of samples C, D and E in the dried condition.

From Table 5 it can be concluded that the maximum transverse elasticity modulus will increase with increased radial dryer stretch.

Table 6 shows the maximum modulus of samples C, D and E in the rewetted condition.

From Tables 5 and 6 it can be seen that the maximum transverse elasticity modulus in a dried and rewet condition is dependent on the transverse orientation conditions of the second bubble. As more transverse orientation forces are applied on the second bubble the modulus will increase in that direction.

### EXAMPLE 3

The influence of the machine direction orientation (MDO) in the first bubble will now be illustrated. The preparation of the cellulose NMMO dope was similar to that of Example 1 and Example 2. Two samples F and G were produced. In the first bubble, a transverse direction orientation (TDO) of 1:1.6 was used in both samples. A varying machine direction orientation (MDO) of 1:3 was used for sample F and a varying machine direction orientation (MDO) of 1:4 was used for sample G. Both samples were precipitated, washed and not plasticized as described in Example 1. Afterwards the film was dried using the same radial dryer stretch of 1:1.53 and the same longitudinal dryer stretch of 1:1.15.

Table 7 shows the strength of samples F and G in the dried condition.

Table 8 shows the strength of samples F and G in the rewet condition.

From Table 7 and 8 it can be concluded that the stress at break in the machine direction will increase with increased machine direction orientation (MDO) in the first bubble.

Table 9 shows the strain at break of samples F and G in the dried condition.

Table 10 shows the strain at break of samples F and G in a rewet condition.

From the above Examples, it can be seen that the strength characteristics of the dried and rewet film may be adjusted by the forces applied to the first and second bubbles.

### EXAMPLE 4

A new set of experiments was conducted by extruding dope containing 9.5% cellulose and applying different transverse direction orientation (TDO) and machine direction orientation (MDO) in the extrusion bubble and in the dryer bubble. The influence on the membrane properties were investigated. The membrane properties were determined by measuring the permeation of K₃Fe(CN)₆ 1% solution at 20° C. through the formed cellulose film sample with a membrane area of 15.92 cm².

The results of the permeation measurements are shown in Table 11.

The permeability of the cellulose film depends on the stretch applied during the formation process and with regard to Table 11 we may conclude that the permeability will decrease with increasing stretch.

TABLE 1

| | | | | | MD stress | TD stress |
|---|---|---|---|---|---|---|
| | MDO | TDO | LDS | RDS | (Mpa) | (Mpa) |
| Sample A: | 1:4 | 1:1.6 | 1:1.15 | 1:16 | 165 | 149 |
| Sample B: | 1:4 | 1:1.8 | 1:1.15 | 1:16 | 176 | 189 |

MDO = Machine Direction Orientation in the first bubble (extrusion draw ratio)
TDO = Transverse Direction Orientation in the first bubble (extrusion blow up ratio)
LDS = Longitudinal Dryer Stretch (dryer length direction draw)
RDS = Radial Dryer Stretch (dryer radial direction blow up)

TABLE 2

| | | | | | MD modulus | TD modulus |
|---|---|---|---|---|---|---|
| | MD | TDO | LDS | RDS | (Mpa) | (Mpa) |
| Sample A | 1:4 | 1:1.6 | 1:1.15 | 1:16 | 8480 | 4910 |
| Sample B | 1:4 | 1:1.8 | 1:1.15 | 1:1.6 | 8150 | 6380 |

TABLE 3
dry stress at break results

| | | | | | MD stress | TD stress |
|---|---|---|---|---|---|---|
| | MDO | TDO | LDS | RDS | (Mpa) | (Mpa) |
| Sample C: | 1:3 | 1:1.6 | 1:1.15 | 1:1.35 | 156 | 131 |
| Sample D: | 1:3 | 1:1.6 | 1:1.15 | 1:1.46 | 160 | 140 |
| Sample E: | 1:3 | 1:1.6 | 1:1.15 | 1:1.53 | 154 | 169 |

TABLE 4
rewet stress at break results

| | | | | | MD stress | TD stress |
|---|---|---|---|---|---|---|
| | MDO | TDO | LDS | RDS | (Mpa) | (Mpa) |
| Sample C: | 1:3 | 1:1.6 | 1:1.15 | 1:1.35 | 22 | 18 |
| Sample D: | 1:3 | 1:1.6 | 1:1.15 | 1:1.46 | 19 | 17 |
| Sample E: | 1:3 | 1:1.6 | 1:1.15 | 1:1.53 | 21 | 22 |

TABLE 5
dry maximum elastic modulus

| | | | | | MD | TD |
|---|---|---|---|---|---|---|
| | | | | | Modulus | Modulus |
| | MDO | TDO | LDS | RDS | (Mpa) | (Mpa) |
| Sample C: | 1:3 | 1:1.6 | 1:1.15 | 1:1.35 | 9310 | 5000 |
| Sample D: | 1:3 | 1:1.6 | 1:1.15 | 1:1.46 | 9210 | 5410 |
| Sample E: | 1:3 | 1:1.6 | 1:1.15 | 1:1.53 | 8950 | 7120 |

TABLE 6
rewet maximum elastic modulus

| | | | | | MD | MD |
|---|---|---|---|---|---|---|
| | | | | | Modulus | Modulus |
| | MDO | TDO | LDS | RDS | (Mpa) | (Mpa) |
| Sample C: | 1:3 | 1:1:6 | 1:1.15 | 1:1.35 | 138 | 78 |
| Sample D: | 1:3 | 1:1.6 | 1:1.15 | 1:1.46 | 131 | 80 |
| Sample E: | 1:3 | 1:1.6 | 1:1.15 | 1:1.53 | 123 | 113 |

TABLE 7
dry stress at break

| | | | | | MD | TD |
|---|---|---|---|---|---|---|
| | | | | | Stress | Stress |
| | MDO | TDO | LDS | RDS | (MPa) | (MPa) |
| Sample F: | 1:3 | 1:1.6 | 1:1.15 | 1:1.53 | 154 | 169 |
| Sample G: | 1:4 | 1:1.6 | 1:1.15 | 1:1.53 | 165 | 149 |

TABLE 8
rewet stress at break

| | | | | | MD | TD |
|---|---|---|---|---|---|---|
| | | | | | Stress | Stress |
| | MDO | TDO | LDS | RDS | (Mpa) | (Mpa) |
| Sample F: | 1:3 | 1:1.6 | 1:1.15 | 1:1.53 | 21 | 22 |
| Sample G: | 1:4 | 1:1.6 | 1:1.15 | 1:1.53 | 23 | 23 |

TABLE 9
strain at break dry condition

| | | | | | MD | TD |
|---|---|---|---|---|---|---|
| | | | | | strain | strain |
| | MDO | TDO | LDS | RDS | (%) | (%) |
| Sample F: | 1:3 | 1:1.6 | 1:1.15 | 1:1.53 | 18 | 24 |
| Sample G: | 1:4 | 1:1.6 | 1:1.15 | 1:1.53 | 21 | 28 |

TABLE 10
rewet strain at break

| | | | | | MD | TD |
|---|---|---|---|---|---|---|
| | | | | | strain | strain |
| | MDO | TDO | LDS | RDS | (%) | (%) |
| Sample F: | 1:3 | 1:1.6 | 1:1.15 | 1:1.53 | 48 | 59 |
| Sample G: | 1:4 | 1:1.6 | 1:1.15 | 1:1.53 | 42 | 78 |

TABLE 11
Permeation values

| | | | | | Permeation value |
|---|---|---|---|---|---|
| Sample ID | MDO | TDO | LDS | RDS | mg μm ml/(min cm²g) |
| 0804/T1 | 1:2.5 | 1:1.27 | 1:1.10 | 1:1 | 425 |
| 0804/T2 | 1:2.5 | 1:1.27 | 1:1.14 | 1:1 | 433 |
| 0605/T1 | 1:2.5 | 1:1.45 | 1:1.10 | 1:1 | 375 |
| 0805/T2 | 1:2.5 | 1:1.45 | 1:1.14 | 1:1 | 385 |
| 0007/T1 | 1:3 | 1:1.27 | 1:1.10 | 1:1 | 380 |
| 0807/T2 | 1:3 | 1:1.25 | 1:1.14 | 1:1 | 375 |
| 0814/T1 | 1:4 | 1:1.27 | 1:1.14 | 1:1.05 | 340 |
| 0814/T2 | 1:4 | 1:1.25 | 1:1.14 | 1:1.25 | 345 |
| 0816/T1 | 1:4 | 1:1.42 | 1:1.14 | 1:1.25 | 340 |
| 0816/T2 | 1:4 | 1:1.42 | 1:1.14 | 1:1.33 | 320 |
| 0809/T1 | 1:5 | 1:1.27 | 1:1.10 | 1:1 | 390 |
| 0809/T2 | 1:5 | 1:1.27 | 1:1.14 | 1:1 | 360 |
| 0809/T3 | 1:5 | 1:1.27 | 1:1.14 | 1:21 | 320 |
| 0809/T4 | 1:5 | 1:1.27 | 1:1.10 | 1:21 | 300 |
| 0813/T1 | 1:5 | 1:1.45 | 1:1.14 | 1:1 | 250 |

1. A method for producing biaxially stretched extruded cellulose based tubular film wherein the tubular film is extruded from an extrusion die and sequentially transporting the tubular film through a liquid precipitation bath and a dryer, said method comprising the steps of:
locating the extrusion die above the liquid precipitation bath having a precipitation liquid level therein to provide a gap between an extrusion nozzle outlet of the extrusion die and the surface of the precipitation liquid in the liquid bath;
extruding a blown tubular film from the extrusion die so that a bubble is formed in the gap between the extrusion nozzle outlet and the liquid precipitation bath and wherein there is increased air pressure within the bubble;
pulling the tubular film away from the extrusion die and into the precipitation bath using a set of rollers;
precipitating the blown tubular film in said liquid precipitation bath; and
wherein the film is transported via further sets of rollers to form at least one further bubble, between a set of rollers, where the tubular film is further stretched to impart additional strength to the film.

2. A method according to claim 1, wherein the tubular film is cellulose based and is formed by adding cellulose to a water diluted NMMO solution to form a suspension, wherein the suspension is heated and the water evaporated under reduced pressure to form NMMO monohydrate which dissolves the cellulose to form a dope solution containing cellulose, NMMO-monohydrate and water.

3. A method according to any preceding claim, wherein nip rolls are used to stretch the tubular film.

4. A method according to claim 3, wherein the nip rolls terminating the first bubble rotate faster than the rate of extrusion from the extrusion die so that there is a longitudinal tension in the tubular cellulose film.

5. A method according to any preceding claim, wherein the air pressure in the first bubble is 0.1 to 5 mbar.

6. A method according to any preceding claim, wherein a second bubble in the tubular film is formed after it has been washed in wash tanks and plasticiser tanks.

7. A method according to any preceding claim, wherein the film is formed into three bubbles prior to being wound on a drum.

8. A method according to claim 7, wherein the second bubble in a wet condition is stretched by nip rolls longitudinally and radially by increased air pressure; and in the third bubble the pressure inside the film is increased.

9. A method according to claim 7, wherein the second bubble in a wet condition is stretched by nip rolls longitudinally and radially by increased air pressure; and in the third bubble the pressure inside the film is decreased.

10. A method according to claim 7, wherein the second bubble is dried and stretched longitudinally by increased air pressure; and the third bubble is rewetted and further stretched between nip rolls and by using increased air pressure.

11. A method according to any preceding claim, wherein the second bubble has a set of nip rolls at both ends of the bubble and wherein the set of nip rolls first in contact with the tubular film rotate slower than the second set of nip rolls whereby a longitudinal tension is created in the film.

12. A method according to any preceding claim, wherein a holding/accumulator tank is located between each set of rollers.

13. A method according to any preceding claim, wherein the air pressure inside the second bubble is 50 to 800 mbar.

14. A method according to any preceding claim, wherein the tube is stretched by a total of 20-1500%, in the longitudinal direction and 20-2000% in the transverse direction.

15. Apparatus for producing biaxially stretched extruded cellulose based tubular film of improved strength wherein the apparatus comprises an extrusion die above a liquid bath having a liquid level therein to provide a gap between the die and the surface of the liquid in the liquid bath wherein the film is extruded into a first bubble and pulled via a set of rollers and wherein the film undergoes a process of being pulled through further rollers between which film bubbles are formed which exert further biaxial forces on the tubular film.

16. Apparatus according to claim 15, wherein the rollers are nip rolls.

17. A biaxially stretched tubular cellulose based film, according to any of claims 1 to 14.

18. A biaxially stretched tubular cellulose film according to claim 17, wherein the tubular cellulose based film is cut into a plurality of biaxially stretched strips and the biaxially stretched strips are seamed to form a smaller dimensioned tubular film.

19. A biaxially stretched tubular cellulose film according to claim 18, wherein the seams are formed by using tape such as adhesive tape, heat sealing tape or any other suitable adhesive means.

20. A biaxially stretched tubular cellulose film according to any of claims 18 and 19, wherein the cuts are parallel with a longitudinal axis of the formed tubular film.

21. A biaxially stretched tubular cellulose film according to any of claims 18 and 19, wherein the cuts are helical with respect to the formed tubular film.
